(19) United States
(12) Patent Application Publication
(10) Pub. No.: US 2014/0063208 A1
(43) Pub. Date: Mar. 6, 2014

(54) MEDICAL IMAGE DIAGNOSTIC APPARATUS, IMAGE PROCESSING APPARATUS, AND ULTRASONIC DIAGNOSTIC APPARATUS

(71) Applicants: Toshiba Medical Systems Corporation, Otawara-shi (JP); Kabushiki Kaisha Toshiba, Tokyo (JP)

(72) Inventors: Takeshi FUKASAWA, Nasushiobara-shi (JP); Kazuhito NAKATA, Otawara-shi (JP); Kenichi UNAYAMA, Otawara-shi (JP); Fumio MOCHIZUKI, Nasushiobara-shi (JP); Takatoshi OKUMURA, Yaita-shi (JP)

(73) Assignees: Toshiba Medical Systems Corporation, Otawara-shi (JP); Kabushiki Kaisha Toshiba, Tokyo (JP)

(21) Appl. No.: 14/076,493

(22) Filed: Nov. 11, 2013

Related U.S. Application Data
(63) Continuation of application No. PCT/JP12/62551, filed on May 16, 2012.

(30) Foreign Application Priority Data
May 23, 2011 (JP) 2011-114918

(51) Int. Cl. H04N 13/04

(52) U.S. Cl. CPC H04N 13/0488
USPC 348/51

(57) ABSTRACT

A medical image diagnostic apparatus according to an embodiment includes a display unit, a rendering processor, a a first controller, and a second controller. The display unit displays a stereoscopic image by displaying a parallax image group. The rendering processor generates the parallax image group by applying a volume rendering process to volume data from a plurality of viewpoints including a reference viewpoint as center. The first controller receives positions of a plurality of reference viewpoints as a position of the reference viewpoint, and causes the rendering processor to generate a parallax image group based on each of the reference viewpoints. The second controller controls to assign and display each of a plurality of parallax image groups to and on corresponding one of a plurality of sections that are divided parts of a display area of the display unit.

### CROSS-REFERENCE TO RELATED APPLICATIONS

This application is a continuation of International Application No. PCT/JP2012/062551, filed on May 16, 2012 which claims the benefit of priority of the prior Japanese Patent Application No. 2011-114918, filed on May 23, 2011, the entire contents of which are incorporated herein by reference.

### FIELD

Embodiments described herein relate generally to a medical image diagnostic apparatus, an image processing apparatus, and an ultrasonic diagnostic apparatus.

### BACKGROUND

Conventionally available is a technology for displaying a stereoscopic image that can be perceived stereoscopically by an observer using special equipment such as a pair of stereoscopic glasses, by displaying two parallax images captured from two viewpoints. In addition, recently available is a technology for displaying a stereoscopic image to an observer with naked eyes, by displaying a multiple-parallax image (e.g., nine parallax images) captured from a plurality of viewpoints onto a monitor, using a light ray controller such as a lenticular lens.

At the same time, among medical image diagnostic apparatuses such as ultrasonic diagnostic apparatuses, X-ray computed tomography (CT) apparatuses, and magnetic resonance imaging (MRI) apparatuses, some apparatuses capable of generating three-dimensional medical image data (volume data) have been put into practical use. Conventionally, volume data generated by such a medical image diagnostic apparatus is converted into a two-dimensional image (rendering image) by various imaging processes (rendering processes), and is displayed onto a general-purpose monitor two-dimensionally. For example, volume data generated by a medical image diagnostic apparatus is converted into a two-dimensional image (volume rendering image) reflected with the three-dimensional information in volume rendering, and displayed onto a general-purpose monitor two-dimensionally.

Also explored is to display volume rendering images generated by applying volume rendering to volume data, having generated by a medical image diagnostic apparatus, from multiple viewpoints onto a stereoscopic monitor, which is mentioned above. However, because a stereoscopic image stereoscopically perceived on a stereoscopic monitor uses a parallax image group in a given parallax number, the volume data cannot be observed simultaneously from a wide area.

### BRIEF DESCRIPTION OF THE DRAWINGS

FIG. 1 is a schematic for explaining an example of a structure of the ultrasonic diagnostic apparatus according to the first embodiment;

FIG. 2A and FIG. 2B are schematics for explaining an example of a stereoscopic display monitor providing a stereoscopic vision using two-parallax images;

FIG. 3 is a schematic for explaining an example of a stereoscopic display monitor providing a stereoscopic vision using nine-parallax images;

FIG. 4 is a schematic for explaining an example of a volume rendering process for generating a parallax image group;

FIG. 5A and FIG. 5B are schematics for explaining an example of a way in which a reference viewpoint position is received;

FIG. 6 is a schematic for explaining an example of how the display area of a monitor is divided;

FIG. 7 is a schematic for explaining terms used in defining a reference viewpoint;

FIG. 8A, FIG. 8B, FIG. 9A, FIG. 9B, FIG. 10, and FIG. 11 are schematics for explaining the example of the controlling process performed by the controller according to the first embodiment;

FIG. 12A, FIG. 12B, and FIG. 12C are schematics for explaining the variation related to how the display area is divided;

FIG. 13 is a flowchart for explaining a process performed by the ultrasonic diagnostic apparatus according to the first embodiment;

FIG. 14 is a schematic for explaining a variation of the first embodiment;

FIG. 15A, FIG. 15B, and FIG. 15C are schematics for explaining the second embodiment; and

FIG. 16 and FIG. 17 are schematics for explaining a variation of the first and the second embodiments.

### DETAILED DESCRIPTION

A medical image diagnostic apparatus according to an embodiment includes a display unit, a rendering processor, a a first controller, and a second controller. The display unit is configured to display a stereoscopic image that is perceived stereoscopically by an observer, by displaying a parallax image group that is parallax images in a given parallax number and having a given parallax angle between the images. The rendering processor is configured to generate the parallax image group by applying a volume rendering process to volume data that is three-dimensional medical image data from a plurality of viewpoints including a reference viewpoint as center. The first controller is configured to receive positions of a plurality of reference viewpoints as a position of the reference viewpoint, and to cause the rendering processor to generate a parallax image group based on each of the reference viewpoints thus received. The second controller configured to control to assign and display each of a plurality of parallax image groups that are based on the respective reference viewpoints to and on corresponding one of a plurality of sections that are divided parts of a display area of the display unit.

An ultrasonic diagnostic apparatus according to an embodiment will be explained in detail with reference to the accompanying drawings.

To begin with, terms used in the embodiment below will be explained. A “parallax image group” is a group of images generated by applying a volume rendering process to volume data while shifting viewpoint positions by a given parallax angle. In other words, a “parallax image group” includes a plurality of “parallax images” each of which has a different “viewpoint position”. A “parallax angle” is an angle determined by adjacent viewpoint positions among viewpoint positions specified for generation of the “parallax image group” and a given position in a space represented by the volume data (e.g., the center of the space). A “parallax number” is the number of “parallax images” required for a stereoscopic vision on a stereoscopic display monitor. A “nine-parallax image” mentioned below means a “parallax image group” with nine “parallax images”. A “two-parallax image” mentioned below means a “parallax image group” with two “parallax images”. A “stereoscopic image” is an image stereoscopically perceived by an observer who is looking at a stereoscopic display monitor displaying a parallax image group.

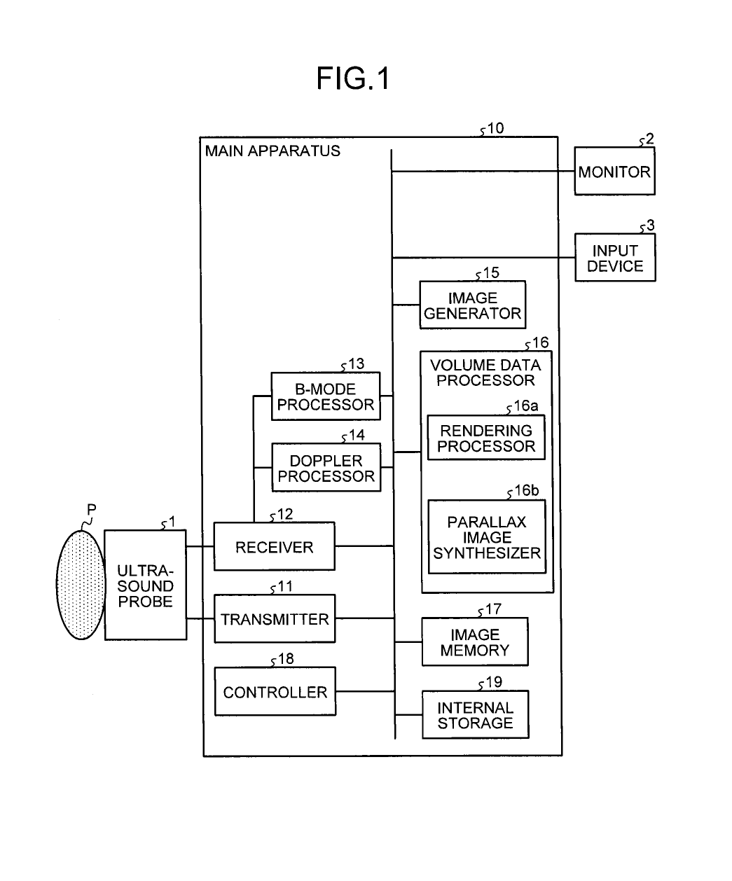

A structure of an ultrasonic diagnostic apparatus according to a first embodiment will be explained. FIG. 1 is a schematic for explaining an example of an exemplary structure of an ultrasonic diagnostic apparatus according to the first embodiment. As illustrated in FIG. 1, the ultrasonic diagnostic apparatus according to the first embodiment includes an ultrasound probe 1, a monitor 2, an input device 3, and a main apparatus 10.

The ultrasound probe 1 includes a plurality of piezoelectric transducer elements. The piezoelectric transducer elements generate ultrasonic waves based on driving signals supplied by a transmitter 11 provided in the main apparatus 10, which is to be explained later. The ultrasound probe 1 also receives reflection waves from a subject P and converts the reflection waves into electrical signals. The ultrasound probe 1 also includes matching layers provided on the piezoelectric transducer elements, and a backing material for preventing the ultrasonic waves from propagating backwardly from the piezoelectric transducer elements. The ultrasound probe 1 is connected to the main apparatus 10 in a removable manner.

When an ultrasonic wave is transmitted from the ultrasound probe 1 toward the subject P, the ultrasonic wave thus transmitted is reflected one after another on a discontinuous acoustic impedance surface in body tissues within the subject P, and received as reflection wave signals by the piezoelectric transducer elements in the ultrasonic probe 1. The amplitude of the reflection wave signals thus received depends on an acoustic impedance difference on the discontinuous surface on which the ultrasonic wave is reflected. When a transmitted ultrasonic wave pulse is reflected on the surface of a moving blood flow or of a cardiac wall, the frequency of the reflection wave signal thus received is shifted by the Doppler shift depending on the velocity component of the moving object with respect to the direction in which the ultrasonic wave is transmitted.

The ultrasound probe 1 according to the first embodiment is an ultrasound probe capable of scanning the subject P two-dimensionally with an ultrasonic wave, and scanning the subject P three-dimensionally with an ultrasonic wave. Specifically, the ultrasound probe 1 according to the first embodiment is a mechanical scanning probe that scans the subject P three-dimensionally by swinging a plurality of ultrasound transducer elements scanning the subject P two-dimensionally at a given angle (swinging angle). The ultrasound probe 1 according to the first embodiment may also be a two-dimensional ultrasound probe enabled to scan the subject P three-dimensionally with an ultrasonic wave using a plurality of ultrasound transducer elements that are arranged in a matrix. Such a two-dimensional ultrasound probe is also capable of scanning the subject P two-dimensionally by converging and transmitting an ultrasonic wave.

The input device 3 includes a mouse, a keyboard, a button, a panel switch, a touch command screen, a foot switch, a track ball, and a joystick, for example. The input device 3 receives various setting requests from an operator of the ultrasonic diagnostic apparatus, and forwards the various setting requests thus received to the main apparatus 10.

The monitor 2 displays a graphical user interface (GUI) for allowing the operator of the ultrasonic diagnostic apparatus to input various setting requests using the input device 3, and an ultrasound image generated by the main apparatus 10, for example.

The monitor 2 according to the first embodiment is a monitor that displays a stereoscopic image that is stereoscopically perceived by an observer by displaying a group of parallax images having a given parallax angle between the images in a given parallax number (hereinafter, referred to as a stereoscopic display monitor). A stereoscopic display monitor will now be explained.

A common, general-purpose monitor that is most widely used today displays two-dimensional images two-dimensionally, and is not capable of displaying a two-dimensional image stereoscopically. If an observer requests a stereoscopic vision on the general-purpose monitor, an apparatus outputting images to the general-purpose monitor needs to display two-parallax images in parallel that can be perceived by the observer stereoscopically, using a parallel technique or a crossed-eye technique. Alternatively, the apparatus outputting images to the general-purpose monitor needs to present images that can be perceived stereoscopically by the observer with anaglyph, which is a pair of glasses having a red filter for the left eye and a blue filter for the right eye, using a complementary color method, for example.

Some stereoscopic display monitors display two-parallax images (also referred to as binocular parallax images) to enable stereoscopic vision using binocular parallax (hereinafter, also mentioned as a two-parallax monitor).

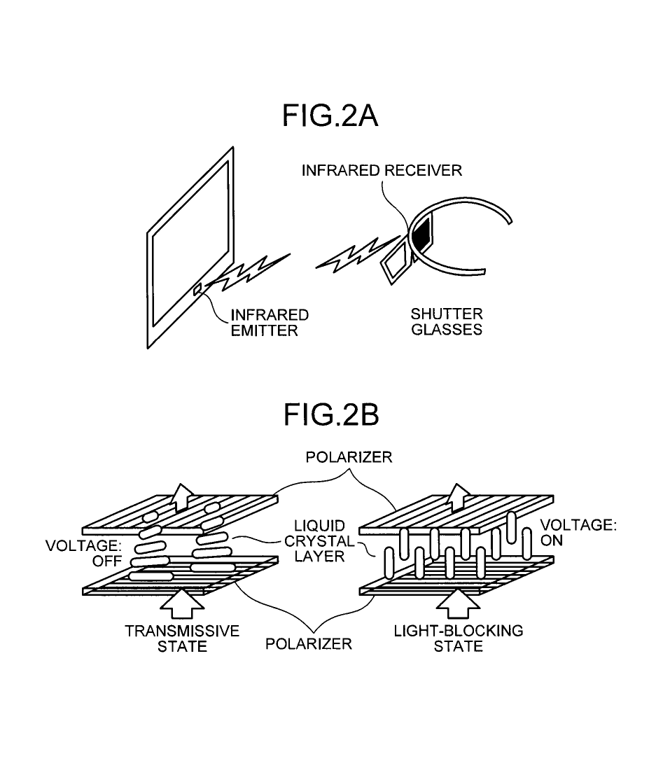

FIGS. 2A and 2B are schematics for explaining an example of a stereoscopic display monitor providing a stereoscopic vision using two-parallax images. The example illustrated in FIGS. 2A and 2B represents a stereoscopic display monitor providing a stereoscopic vision using a shutter technique. In this example, a pair of shutter glasses is used as stereoscopic glasses worn by an observer who observes the monitor. The stereoscopic display monitor outputs two-parallax images onto the monitor alternatingly. For example, the monitor illustrated in FIG. 2A outputs an image for the left eye and an image for the right eye alternatingly at 120 hertz. An infrared emitter is installed in the monitor, as illustrated in FIG. 2A, and the infrared emitter controls infrared outputs based on the timing at which the images are swapped.

The infrared output from the infrared emitter is received by an infrared receiver provided on the shutter glasses illustrated in FIG. 2A. A shutter is installed on the frame on each side of the shutter glasses. The shutter glasses switch the right shutter and the left shutter between a transmissive state and a light-blocking state alternatingly, based on the timing at which the infrared receiver receives infrared. A process of switching the shutters between the transmissive state and the light-blocking state will now be explained.

As illustrated in FIG. 2B, each of the shutters includes an incoming polarizer and an outgoing polarizer, and also includes a liquid crystal layer interposed between the incoming polarizer and the outgoing polarizer. The incoming polarizer and the outgoing polarizer are orthogonal to each other, as illustrated in FIG. 2B. In an “OFF” state during which a voltage is not applied as illustrated in FIG. 2B, the light having passed through the incoming polarizer is rotated by 90 degrees by the effect of the liquid crystal layer, and thus passes through the outgoing polarizer. In other words, a shutter with no voltage applied is in the transmissive state.

By contrast, as illustrated in FIG. 2B, in an “ON” state during which a voltage is applied, the polarization rotation effect of liquid crystal molecules in the liquid crystal layer is lost. Therefore, the light having passed through the incoming polarizer is blocked by the outgoing polarizer. In other words, the shutter applied with a voltage is in the light-blocking state.

The infrared emitter outputs infrared for a time period while which an image for the left eye is displayed on the monitor, for example. During the time the infrared receiver is receiving infrared, no voltage is applied to the shutter for the left eye, while a voltage is applied to the shutter for the right eye. In this manner, as illustrated in FIG. 2A, the shutter for the right eye is in the light-blocking state and the shutter for the left eye is in the transmissive state to cause the image for the left eye to enter the left eye of the observer. For a time period while which an image for the right eye is displayed on the monitor, the infrared emitter stops outputting infrared. When the infrared receiver receives no infrared, a voltage is applied to the shutter for the left eye, while no voltage is applied to the shutter for the right eye. In this manner, the shutter for the left eye is in the light-blocking state, and the shutter for the right eye is in the transmissive state to cause the image for the right eye to enter the right eye of the observer. As explained above, the stereoscopic display monitor illustrated in FIGS. 2A and 2B makes a display that can be stereoscopically perceived by the observer, by switching the states of the shutters in association with the images displayed on the monitor.

In addition to apparatuses providing a stereoscopic vision using the shutter technique, known as two-parallax monitors are an apparatus using a pair of polarized glasses and an apparatus using a parallax barrier and providing a stereoscopic vision.

Some stereoscopic display monitors that have recently been put into practical use allow multiple parallax images, e.g., nine-parallax images, to be stereoscopically viewed by an observer with the naked eyes, by adopting a light ray controller such as a lenticular lens. This type of stereoscopic display monitor enables stereoscopic viewing due to binocular parallax, and further enables stereoscopic viewing due to motion parallax that provides an image varying according to motion of the viewpoint of the observer.

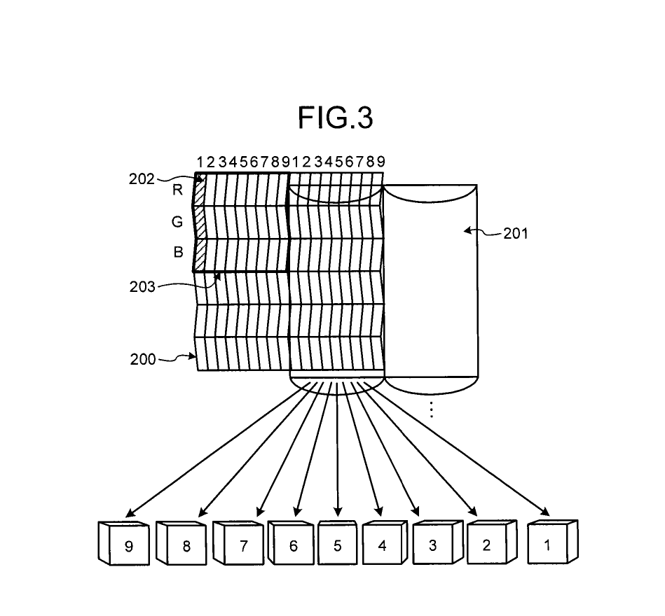

FIG. 3 is a schematic for explaining an example of a stereoscopic display monitor providing a stereoscopic vision using nine-parallax images. In the stereoscopic display monitor illustrated in FIG. 3, a light ray controller is arranged on the front surface of a flat display screen 200 such as a liquid crystal panel. For example, in the stereoscopic display monitor illustrated in FIG. 3, a vertical lenticular sheet 201 having an optical aperture extending in a vertical direction is fitted on the front surface of the display screen 200 as a light ray controller. Although the vertical lenticular sheet 201 is fitted so that the convex of the vertical lenticular sheet 201 faces the front side in the example illustrated in FIG. 3, the vertical lenticular sheet 201 may be also fitted so that the convex faces the display screen 200.

As illustrated in FIG. 3, the display screen 200 has pixels 202 that are arranged in a matrix. Each of the pixels 202 has an aspect ratio of 3:1, and includes three sub-pixels of red (R), green (G), and blue (B) that are arranged vertically. The stereoscopic display monitor illustrated in FIG. 3 converts nine-parallax images consisting of nine images into an intermediate image in a given format (e.g., a grid-like format), and outputs the result onto the display screen 200. In other words, the stereoscopic display monitor illustrated in FIG. 3 assigns and outputs nine pixels located at the same position in the nine-parallax images to the pixels 202 arranged in nine columns. The pixels 202 arranged in nine columns function as a unit pixel set 203 that displays nine images from different viewpoint positions at the same time.

The nine-parallax images simultaneously output as the unit pixel set 203 onto the display screen 200 are radiated with a light emitting diode (LED) backlight, for example, as parallel rays, and travel further in multiple directions through the vertical lenticular sheet 201. Light for each of the pixels included in the nine-parallax images is output in multiple directions, whereby the light entering the right eye and the left eye of the observer changes as the position (viewpoint position) of the observer changes. In other words, depending on the angle from which the observer perceives, the parallax image entering the right eye and the parallax image entering the left eye are at different parallax angles. Therefore, the observer can perceive a captured object stereoscopically from any one of the nine positions illustrated in FIG. 3, for example. At the position “5” illustrated in FIG. 3, the observer can perceive the captured object stereoscopically as the object faces directly the observer. At each of the positions other than the position “5” illustrated in FIG. 3, the observer can perceive the captured object stereoscopically with its orientation changed. The stereoscopic display monitor illustrated in FIG. 3 is merely an example. The stereoscopic display monitor for displaying nine-parallax images may be a liquid crystal with horizontal stripes of “RRR GGG . . . , BBB . . . ” as illustrated in FIG. 3, or a liquid crystal with vertical stripes of “RGBRGB . . . ”. The stereoscopic display monitor illustrated in FIG. 3 may be a monitor using a vertical lens in which the lenticular sheet is arranged vertically as illustrated in FIG. 3, or a monitor using a diagonal lens in which the lenticular sheet is arranged diagonally. Hereinafter, the stereoscopic display monitor explained with reference to FIG. 3 is referred to as a nine-parallax monitor.

In other words, the two-parallax monitor is a stereoscopic display monitor that displays a stereoscopic image that is perceived by an observer by displaying a parallax image group that are two parallax images having a given parallax angle between these images (two-parallax image). The nine-parallax monitor is a stereoscopic display monitor that displays a stereoscopic image that is perceived by an observer by displaying a parallax image group that are nine parallax images having a given parallax angle between the images (nine-parallax images).

The first embodiment is applicable to both examples in which the monitor 2 is a two-parallax monitor, and in which the monitor 2 is a nine-parallax monitor. Explained below is an example in which the monitor 2 is a nine-parallax monitor.

Referring back to FIG. 1, the main apparatus 10 is an apparatus that generates ultrasound image data based on reflection waves received by the ultrasound probe 1. Specifically, the main apparatus 10 according to the first embodiment is an apparatus that is cable of generating three-dimensional ultrasound image data based on three-dimensional reflection wave data received by the ultrasound probe 1. Hereinafter, three-dimensional ultrasound image data is referred to as “volume data”.

As illustrated in FIG. 1, the main apparatus 10 includes a transmitter 11, a receiver 12, a B-mode processor 13, a Doppler processor 14, an image generator 15, a volume data processor 16, an image memory 17, a controller 18, and an internal storage 19.

The transmitter 11 includes a trigger generator circuit, a transmission delay circuit, a pulser circuit, and the like, and supplies a driving signal to the ultrasound probe 1. The pulser circuit generates a rate pulse used in generating ultrasonic waves to be transmitted, repeatedly at a given rate frequency. The transmission delay circuit adds a delay time corresponding to each of the piezoelectric transducer elements to each of the rate pulses generated by the pulser circuit. Such a delay time is required for determining transmission directivity by converging the ultrasonic waves generated by the ultrasound probe 1 into a beam. The trigger generator circuit applies a driving signal (driving pulse) to the ultrasound probe 1 at the timing of the rate pulse. In other words, by causing the delay circuit to change the delay time to be added to each of the rate pulses, the direction in which the ultrasonic wave is transmitted from a surface of the piezoelectric transducer element is arbitrarily adjusted.

The transmitter 11 has a function of changing a transmission frequency, a transmission driving voltage, and the like instantaneously before executing a certain scan sequence, based on an instruction of the controller 18 to be described later. In particular, a change in the transmission driving voltage is performed by a linear amplifier type transmission circuit that is cable of switching its values instantaneously, or a mechanism for electrically switching a plurality of power units.

The receiver 12 includes an amplifier circuit, an analog-to-digital (A/D) converter, an adder, and the like. The receiver 12 generates reflection wave data by applying various processes to the reflection wave signals received by the ultrasound probe 1. The amplifier circuit amplifies the reflection wave signal on each channel, and performs a gain correction. The A/D converter performs an A/D conversion to the reflection wave signal having gain corrected, and adds a delay time required for determining reception directivity to the digital data. The adder performs an addition to the reflection wave signals processed by the A/D converter, to generate the reflection wave data. Through the addition performed by the adder, a reflection component in the direction corresponding to the reception directivity of the reflection wave signals is emphasized.

In the manner described above, the transmitter 11 and the receiver 12 control the transmission directivity and the reception directivity of the ultrasonic wave transmissions and receptions, respectively.

The transmitter 11 according to the first embodiment transmits a three-dimensional ultrasound beam from the ultrasound probe 1 toward the subject P. The receiver 12 according to the first embodiment generates three-dimensional reflection wave data from three-dimensional reflection wave signals received by the ultrasound probe 1.

The B-mode processor 13 receives the reflection wave data from the receiver 12, and performs a logarithmic amplification, an envelope detection, and the like, to generate data (B-mode data) in which signal intensity is represented as a luminance level.

The Doppler processor 14 analyzes the frequencies in velocity information included in the reflection wave data received from the receiver 12, and extracts blood flow, tissue, and contrast agent echo components resulted from the Doppler shift, and generates data (Doppler data) that is moving object information such as an average velocity, a variance, a power, and the like extracted for a plurality of points.

The B-mode processor 13 and the Doppler processor 14 according to the first embodiment are capable of processing both of two-dimensional reflection wave data and three-dimensional reflection wave data. In other words, the B-mode processor 13 generates three-dimensional B-mode data from three-dimensional reflection wave data, as well as generating two-dimensional B-mode data from two-dimensional reflection wave data. The Doppler processor 14 generates two-dimensional Doppler data from two-dimensional reflection wave data, and generating three-dimensional Doppler data from three-dimensional reflection wave data.

The image generator 15 generates ultrasound image data from the data generated by the B-mode processor 13 and the data generated by the Doppler processor 14. In other words, the image generator 15 generates B-mode image data in which the intensity of a reflection wave is represented in luminance, from the two-dimensional B-mode data generated by the B-mode processor 13. The image generator 15 also generates an average velocity image, a variance image, or a power image representing moving object information, or a color Doppler image data being a combination of these images, from the two-dimensional Doppler data generated by the Doppler processor 14.

Generally, the image generator 15 converts rows of scan line signals from an ultrasound scan into rows of scan line signals in a video format, typically one used for television (performs a scan conversion), to generate ultrasound image data to be displayed. Specifically, the image generator 15 generates ultrasound image data to be displayed by performing a coordinate conversion in accordance with a way in which an ultrasound scan is performed with the ultrasound probe 1. The image generator 15 also synthesizes various character information for various parameters, scales, body marks, and the like to the ultrasound image data.

The image generator 15 also generates three-dimensional B-mode image data by performing a coordinate conversion to the three-dimensional B-mode data generated by the B-mode processor 13. The image generator 15 also generates three-dimensional color Doppler image data by performing a coordinate conversion to the three-dimensional Doppler data generated by the Doppler processor 14. In other words, the image generator 15 generates “three-dimensional B-mode image data or three-dimensional color Doppler image data” being “volume data that is three-dimensional ultrasound image data”.

The volume data processor 16 generates ultrasound image data to be displayed from the volume data generated by the image generator 15.

Specifically, the volume data processor 16 includes a rendering processor 16a and a parallax image synthesizer 16b, as illustrated in FIG. 1.

The rendering processor 16a is a processor that performs a rendering process to the volume data, in order to generate various images (two-dimensional images) so that the volume data can be displayed onto the monitor 2. The rendering process performed by the rendering processor 16a includes a process of reconstructing a multi-planer reconstruction (MPR) image from the volume data by performing a multi-planer reconstruction. The rendering process performed by the rendering processor 16a also includes a process of applying a “curved MPR” to the volume data, and a process of applying “intensity projection” to the volume data.

The rendering processes performed by the rendering processor 16a also include volume rendering process for generating a two-dimensional image (volume rendering image) reflected with three-dimensional information. In other words, the rendering processor 16a generates a parallax image group by performing volume rendering processes to volume data that is three-dimensional ultrasound image data from a plurality of viewpoints having the center at a reference viewpoint. Specifically, because the monitor 2 is a nine-parallax monitor, the rendering processor 16a generates nine-parallax images by performing volume rendering processes to the volume data from nine viewpoints having the center at the reference viewpoint.

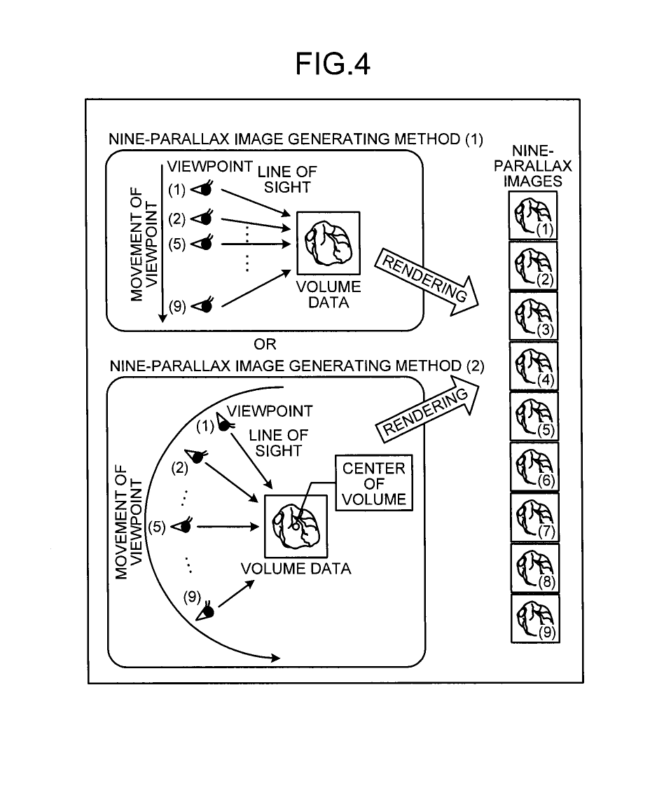

The rendering processor 16a generates nine-parallax images by performing a volume rendering process illustrated in FIG. 4 under the control of the controller 18, which is to be described later. FIG. 4 is a schematic for explaining an example of a volume rendering process for generating a parallax image group.

For example, it is assumed herein that the rendering processor 16a receives parallel projection as a rendering condition, and a reference viewpoint position (5) and a parallax angle of “one degree”, as illustrated in a “nine-parallax image generating method (1)” in FIG. 4. In such a case, the rendering processor 16a generates nine-parallax images, each having a parallax angle (angle between the lines of sight) shifted by one degree, by parallel projection, by moving a viewpoint position from (1) to (9) in such a way that the parallax angle is set in every “one degree”. Before performing parallel projection, the rendering processor 16a establishes a light source radiating parallel light rays from the infinity along the line of sight.

Alternatively, it is assumed that the rendering processor 16a receives perspective projection as a rendering condition, and a reference viewpoint position (5) and a parallax angle of “one degree”, as illustrated in “nine-parallax image generating method (2)” in FIG. 4. In such a case, the rendering processor 16a generates nine-parallax images, each having a parallax angle shifted by one degree, by perspective projection, by moving the viewpoint position from (1) to (9) around the center (the center of gravity) of the volume data in such a way that the parallax angle is set in every “one degree”. Before performing perspective projection, the rendering processor 16a establishes a point light source or a surface light source radiating light three-dimensionally about the line of sight, for each of the viewpoints. Alternatively, when perspective projection is to be performed, the viewpoints (1) to (9) may be shifted in parallel depending on rendering conditions.

The rendering processor 16a may also perform a volume rendering process using both parallel projection and perspective projection, by establishing a light source radiating light two-dimensionally, radially from a center on the line of sight for the vertical direction of the volume rendering image to be displayed, and radiating parallel light rays from the infinity along the line of sight for the horizontal direction of the volume rendering image to be displayed.

The nine-parallax images thus generated correspond to a parallax image group. In other words, the parallax image group is a group of ultrasound images for a stereoscopic vision, generated from the volume data.

When the monitor 2 is a two-parallax monitor, the rendering processor 16a generates two-parallax images by setting two viewpoints, for example, having a parallax angle of “one degree” from the center at the reference viewpoint.

The image generator 15 synthesizes information other than the parallax image group (e.g., character information, scales, body marks) to the parallax image group to be displayed, and outputs the result to the monitor 2 as video signals, under the control of the controller 18.

The parallax image synthesizer 16b illustrated in FIG. 1 generates a synthesized image group that is to be used as a parallax image group, by synthesizing a plurality of parallax image groups each of which is generated by the rendering processor 16a using a different reference viewpoint. The parallax image synthesizer 16b will be described later in detail.

The image memory 17 is a memory for storing therein image data generated by the image generator 15 and the volume data processor 16. The image memory 17 can also store therein data generated by the B-mode processor 13 and the Doppler processor 14.

The internal storage 19 stores therein control programs for transmitting and receiving ultrasonic waves, performing image processes and displaying processes, and various data such as diagnostic information (e.g., a patient identification (ID) and observations by a doctor), a diagnostic protocol, and various body marks, and the like. The internal storage 19 is also used for storing therein the image data stored in the image memory 17, for example, as required.

The controller 18 controls the entire process performed by the ultrasonic diagnostic apparatus. Specifically, the controller 18 controls the processes performed by the transmitter 11, the receiver 12, the B-mode processor 13, the Doppler processor 14, the image generator 15, and the volume data processor 16 based on various setting requests input by the operator via the input device 3, or various control programs and various data read from the internal storage 19.

The controller 18 also controls to display ultrasound image data to be displayed stored in the image memory 17 or the internal storage 19 onto the monitor 2. Specifically, the controller 18 according to the first embodiment displays a stereoscopic image that can be perceived stereoscopically by an observer (an operator of the ultrasonic diagnostic apparatus) by converting the nine-parallax images into an intermediate image in which the parallax image group is arranged in a predetermined format (e.g., a grid-like format), and outputting the intermediate image to the monitor 2 being a stereoscopic display monitor.

The overall structure of the ultrasonic diagnostic apparatus according to the first embodiment is explained above. The ultrasonic diagnostic apparatus according to the first embodiment having such a structure generates volume data that is three-dimensional ultrasound image data, and generates a parallax image group from the ultrasound volume data thus generated. The ultrasonic diagnostic apparatus according to the first embodiment then displays the parallax image group onto the monitor 2. In this manner, an observer who is an operator of the ultrasonic diagnostic apparatus can observe the three-dimensional ultrasound image data stereoscopically.

However, because a stereoscopic image perceived stereoscopically on the monitor 2 being a stereoscopic monitor uses a parallax image group in a given parallax number, e.g., nine-parallax images, the volume data cannot be observed simultaneously from a wide area.

In response to this issue, the controller 18 in the ultrasonic diagnostic apparatus according to the first embodiment performs control to be explained below, so as to enable three-dimensional ultrasound image data to be stereoscopically observed simultaneously from a wide area.

In a first control, the controller 18 according to the first embodiment receives a plurality of reference viewpoint positions as a reference viewpoint position, and causes the rendering processor 16a to generate a parallax image group based on each one of the reference viewpoints thus received. In the first embodiment to be explained below, the controller 18 receives a plurality of reference viewpoint positions by sequentially receiving changes in the reference viewpoint position in a temporal order. Therefore, every time a change in the reference viewpoint position is received, the controller 18 according to the first embodiment causes the rendering processor 16a to generate a parallax image group based on the reference viewpoint after the change thus received, as a first control.

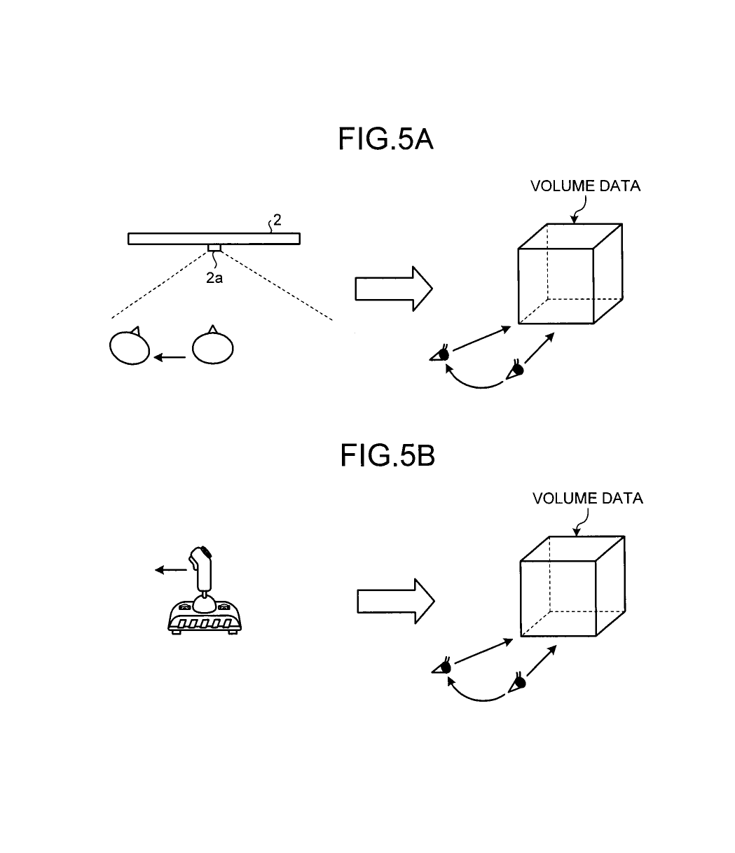

Approaches for allowing the controller 18 to receive changes in the reference viewpoint position in the first control will now be explained using FIGS. 5A and 5B. FIGS. 5A and 5B are schematics for explaining an example of how changes in the reference viewpoint position are received.

The example illustrated in FIG. 5A depicts an approach in which a camera 2a mounted on the monitor 2 is used as a detector for detecting a movement of the observer. In other words, the camera 2a captures the image of the observer to detect a movement of the observer, as illustrated in FIG. 5A. The controller 18 then receives a change in the reference viewpoint position based on the movement of the observer with respect to the monitor 2 (the amount and the direction of the movement) detected by the camera 2a being a detector, as illustrated in FIG. 5A.

Specifically, the camera 2a has a face recognition function. The camera 2a keeps track of the face of the observer in the real space using the face recognition function, and transfers the amount and the direction of the recognized movement of the face of the observer with respect to the monitor 2 to the controller 18. The controller 18 then changes the reference viewpoint position for the volume data, correspondingly to the amount and the direction of the movement of the face of the observer with respect to the monitor 2.

The example illustrated in FIG. 5B depicts an approach in which a joystick provided to the input device 3 is used. The joystick provided to the input device 3 receives an operation for changing the reference viewpoint position, as illustrated in FIG. 5B. Specifically, the joystick receives an operation for changing the reference viewpoint position from the observer of the monitor 2. The controller 18 then receives a change in the reference viewpoint position based on information of the observer operation received by the joystick provided to the input device 3, as illustrated in FIG. 5B.

Specifically, the observer moves the joystick to change the reference viewpoint position to the position the observer wants to observe. The joystick transfers the direction and the amount in and by which the joystick is moved to the controller 18. The controller 18 changes the reference viewpoint position of the volume data correspondingly to the amount and the direction in and by which the joystick is moved. A joystick is merely an example, and the input device 3 used in receiving a change in the reference viewpoint position based on information of an observer operation may also be a trackball or a mouse, for example.

Upon receiving a change in the reference viewpoint position, the controller 18 causes the rendering processor 16a to generate a parallax image group based on the reference viewpoint after the change.

As a second control, the controller 18 according to the first embodiment controls to assign and display each of the parallax image groups that are based on the respective reference viewpoints to and on corresponding one of a plurality of sections being divided parts of the display area of the monitor 2. In the first embodiment in which changes in the reference viewpoint position are sequentially received in the temporal order, the controller 18 controls to assign and display a parallax image group based on the reference viewpoint after the change and a parallax image group based on the reference viewpoint before the change to and on each of the sections being divided parts of the display area of the monitor 2, as the second control. Hereunder, the parallax image group based on the reference viewpoint after the change is sometimes referred to as a “first parallax image group”, and the parallax image group based on the reference viewpoint before the change is sometimes referred to as a “second parallax image group”.

Specifically, as the second control, the controller 18 according to the first embodiment divides the display area of the monitor 2 into a plurality of sections, in order to display the first parallax image group and the second parallax image group simultaneously. As the second control, the controller 18 according to the first embodiment causes the parallax image synthesizer 16b to generate a synthesized image group including the first parallax image group and the second parallax image group, in a manner corresponding to a pattern in which the display area is divided. The controller 18 according to the first embodiment then displays the synthesized image group generated by the parallax image synthesizer 16b onto the monitor 2.

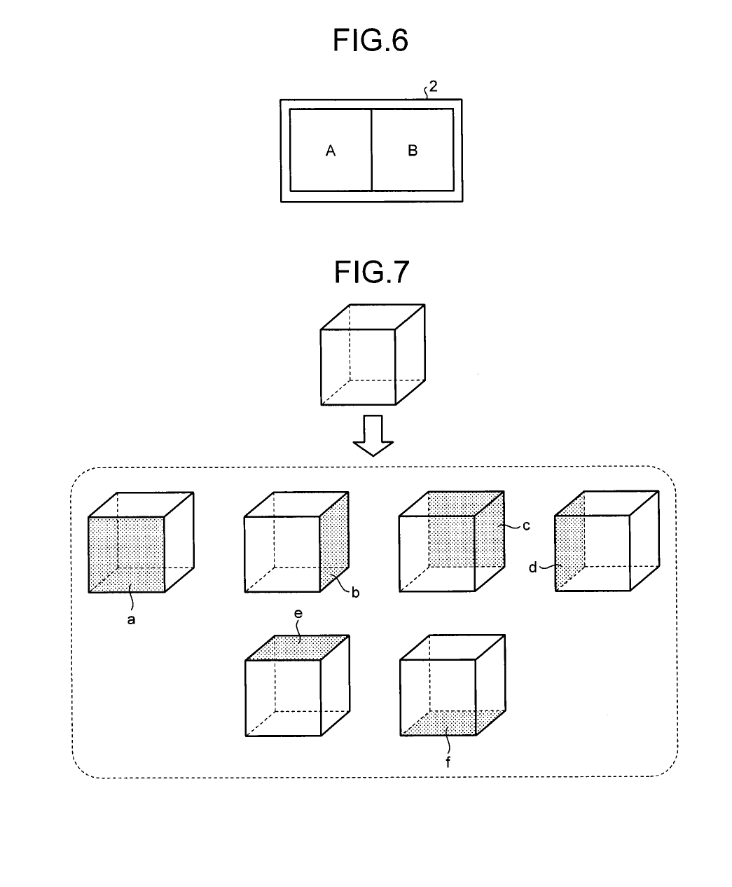

An example in which the controller 18 divides the display area of the monitor 2 in the second control will be explained with reference to FIG. 6. FIG. 6 is a schematic for explaining an example how the display area of the monitor is divided.

For example, as illustrated in FIG. 6, the controller 18 sets a “section A” and a “section B” being two laterally divided parts of the display area of the monitor 2. In response to such a setting, the parallax image synthesizer 16b generates a synthesized image group in which the first parallax image group and the second parallax image group are arranged in parallel along a lateral direction. In other words, the controller 18 assigns the first parallax image group and the second parallax image group to a plurality of sections, by causing the parallax image synthesizer 16b to generate a synthesized image group.

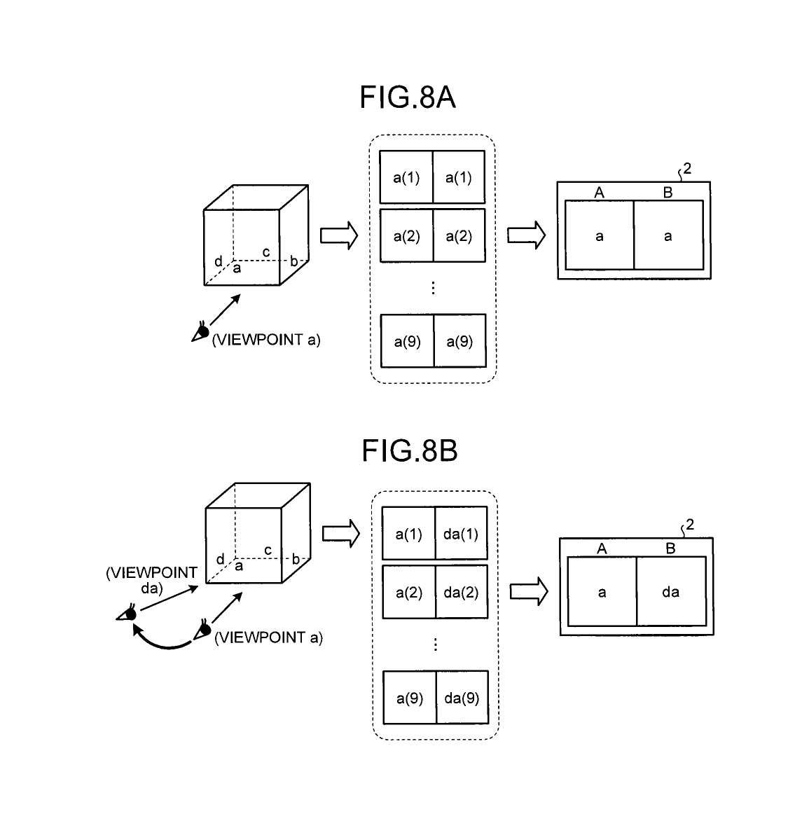

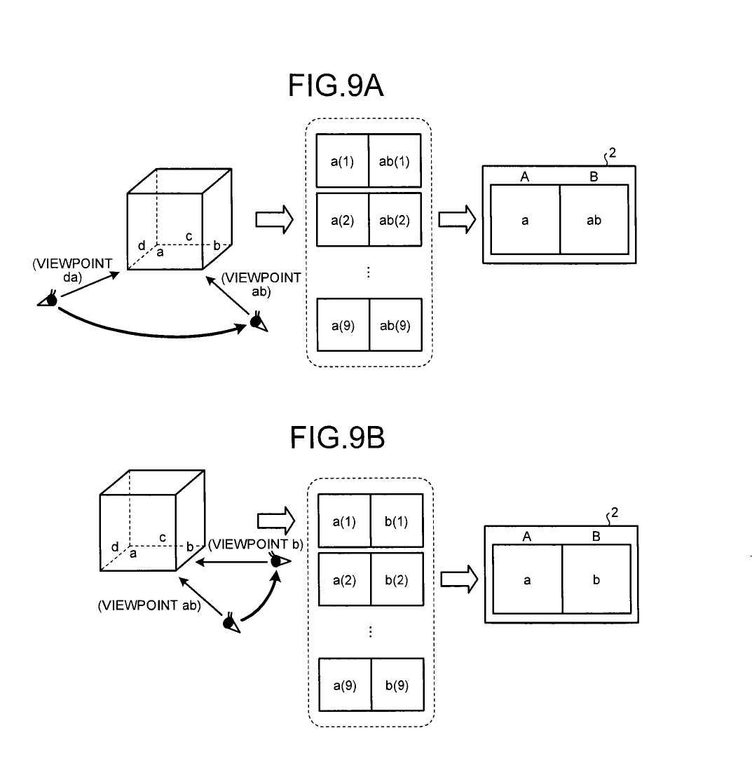

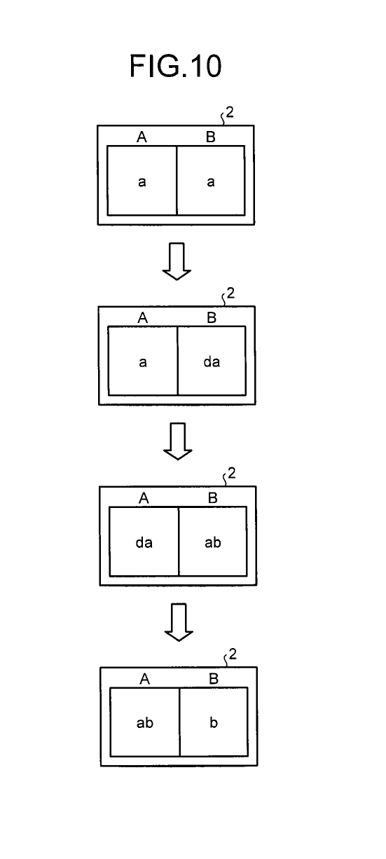

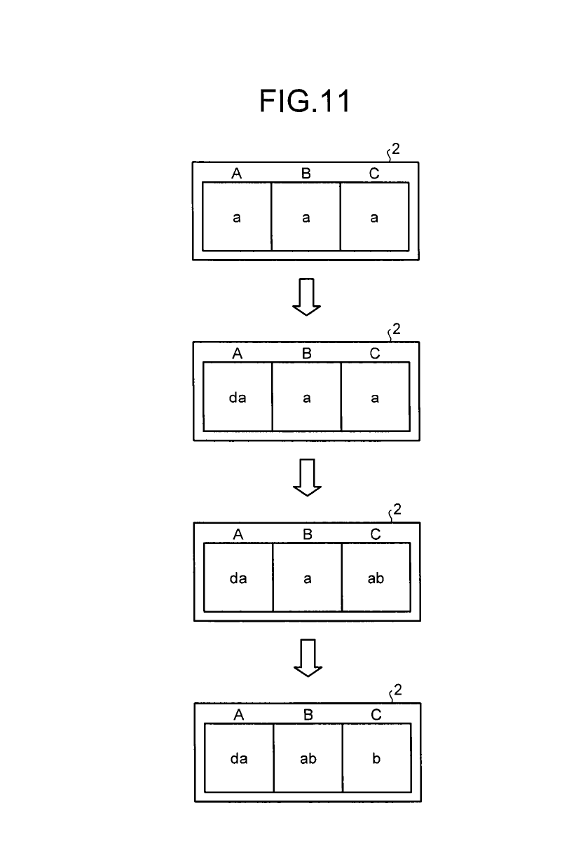

The first control and the second control performed by the controller 18 will now be explained more in detail with reference to FIGS. 7, 8A, 8B, 9A, 9B, 10, and 11. FIG. 7 is a schematic for explaining terms used in defining reference viewpoints, and FIGS. 8A, 8B, 9A, 9B, 10, and 11 are schematics for explaining an example of a controlling process performed by the controller according to the first embodiment.

To describe a reference viewpoint position, definitions illustrated in FIG. 7 are used. In the example illustrated in FIG. 7, volume data is depicted as a cube. In the example illustrated in FIG. 7, the surface of the volume data located closer to a viewer is defined as “a”. The right one of the surfaces located adjacent to the surface “a” is defined as “b”. The surface facing the surface “a” is defined as “c”. In the example illustrated in FIG. 7, the left one of the surfaces located adjacent to the surface “a” is defined as “d”. In the example illustrated in FIG. 7, the upper one of the surfaces located adjacent to the surface “a” is defined as “e”, and the lower one of the surfaces located adjacent to the surface “a” is defined as “f”.

A viewpoint viewing the surface “a” from a position directly facing the surface “a” is defined as a “viewpoint a”. Similarly, a viewpoint viewing the surface “b” from a position directly facing the surface “b” is defined as a “viewpoint b”. Similarly, a viewpoint viewing the surface “c” from a position directly facing the surface “c” is defined as a “viewpoint c”. Similarly, a viewpoint viewing the surface “d” from a position directly facing the surface “d” is defined as a “viewpoint d”. Similarly, a viewpoint viewing the surface “e” from a position directly facing the surface “e” is defined as a “viewpoint e”. Similarly, a viewpoint viewing the surface “f” from a position directly facing the surface “f” is defined as a “viewpoint f”.

To begin with, it is assumed that the controller 18 receives the “viewpoint a” as an initial reference viewpoint, as illustrated in FIG. 8A. In such a case, the controller 18 causes the rendering processor 16a to generate nine-parallax images “a(1) to a(9)” by setting nine viewpoints including the viewpoint a as the center. As illustrated in FIG. 8A, the controller 18 then causes the parallax image synthesizer 16b to generate a synthesized image group synthesized with each one of the nine-parallax images “a(1) to a(9)” (a synthesized image of the nine images) arranged twice in the lateral direction. In other words, the parallax image synthesizer 16b generates a group of a synthesized image “a(1), a(1)”, a synthesized image “a(2), a(2)”, . . . , and a synthesized image “a(9), a(9)” as illustrated in (A) in FIG. 8.

The controller 18 then displays the nine synthesized images illustrated in FIG. 8A onto the monitor 2. In this manner, an observer can observe a “stereoscopic image a” in which the volume data is observed from the viewpoint a, in both of the section A and the section B.

It is now assumed that the controller 18 then receives a change in the reference viewpoint from the “viewpoint a” to the “viewpoint da” that is located between the “viewpoint a” and the “viewpoint d”, as illustrated in FIG. 8B. In such a situation, the controller 18 causes the rendering processor 16a to generate nine-parallax images “da(1) to da(9)” by setting nine viewpoints including the viewpoint da as the center. The controller 18 then causes the parallax image synthesizer 16b to generate a synthesized image group (nine synthesized images) in which the nine-parallax images “a(1) to a(9)” before the change are assigned to the section A, and the nine-parallax images “da(1) to da(9)” after the change are assigned to the section B, as illustrated in FIG. 8B. In other words, the parallax image synthesizer 16b generates a group of a synthesized image “a(1), da(1)”, a synthesized image “a(2), da(2)”, . . . , and a synthesized image “a(9), da(9)”, as illustrated in FIG. 8B.

The controller 18 then displays the nine synthesized images illustrated in FIG. 8B onto the monitor 2. In this manner, the observer can observe the “stereoscopic image a” representing the volume data observed from the viewpoint a in the section A, and the “stereoscopic image da” representing the volume data observed from the viewpoint da in the section B.

It is now assumed that the controller 18 then receives a change in the reference viewpoint from the “viewpoint da” to a “viewpoint ab” located between the “viewpoint a” and the “viewpoint b”, as illustrated in FIG. 9A. In such a situation, the controller 18 causes the rendering processor 16a to generate nine-parallax images “ab(1) to ab(9)” by setting nine viewpoints including the viewpoint ab as the center. The controller 18 then causes the parallax image synthesizer 16b to generate a synthesized image group (nine synthesized images) in which the nine-parallax images “a(1) to a(9)” before the change are assigned to the section A and the nine-parallax images “ab(1) to ab(9)” after the change assigned are to the section B, as illustrated in FIG. 9A. In other words, the parallax image synthesizer 16b generates a group of a synthesized image “a(1), ab(1)”, a synthesized image “a(2), ab(2)”, . . . , and a synthesized image “a(9), ab(9)”, as illustrated in FIG. 9A.

The controller 18 then displays the nine synthesized images illustrated in FIG. 9A onto the monitor 2. In this manner, the observer can observe the “stereoscopic image a” representing the volume data observed from the viewpoint a in the section A, and observe a “stereoscopic image ab” representing the volume data observed from the viewpoint ab in the section B.

It is now assumed that the controller 18 then receives a change in the reference viewpoint from the “viewpoint ab” to the “viewpoint b”, as illustrated in FIG. 9B. In such a situation, the controller 18 causes the rendering processor 16a to generate nine-parallax images “b(1) to b(9)” by setting nine viewpoints including the viewpoint b as the center. The controller 18 causes the parallax image synthesizer 16b to generate a synthesized image group (nine synthesized images) in which the nine-parallax images “a(1) to a(9)” before the change are assigned to the section A and the nine-parallax images “b(1) to b(9)” after the change are assigned to the section B, as illustrated in FIG. 9B. In other words, the parallax image synthesizer 16b generates a group of “a synthesized image “a(1), b(1)”, a synthesized image “a(2), b(2)”, . . . , and a synthesized image “a(9), b(9)”, as illustrated in FIG. 9B.

The controller 18 then displays the nine synthesized image illustrated in FIG. 9B onto the monitor 2. In this manner, the observer can observe a “stereoscopic image a” representing the volume data observed from the viewpoint a in the section A, and a “stereoscopic image b” representing the volume data observed from the viewpoint b in the section B.

Explained in the example illustrated in FIGS. 8A, 8B, 9A, and 9B is an example in which the parallax image group before a change, that is, the first parallax image group, is fixed to the parallax image group using the first reference viewpoint received. However, the embodiment may represent an example in which the parallax image group before the change is switched to a parallax image group using a reference viewpoint immediately before the change of the reference viewpoint, under the control of the controller 18.

Specifically, the controller 18 controls to assign the parallax image group immediately before the change to the section A, and to assign the parallax image group after the change to the section B. For example, it is assumed that the reference viewpoint is changed in a sequence of the “viewpoint a”, the “viewpoint da”, the “viewpoint ab”, and the “viewpoint b”, as illustrated in FIGS. 8A, 8B, 9A, and 9B. In such a case, to begin with, the controller 18 assigns the nine-parallax images representing the “stereoscopic image a” to the section A and to the section B, as illustrated in FIG. 10. When the reference viewpoint is changed from the “viewpoint a” to the “viewpoint da”, the controller 18 assigns the nine-parallax images representing the “stereoscopic image a” to the section A, and assigns the nine-parallax images representing the “stereoscopic image da” to the section B, as illustrated in FIG. 10.

When the reference viewpoint is changed from the “viewpoint da” to the “viewpoint ab”, the controller 18 assigns the nine-parallax images representing the “stereoscopic image da” to the section A, and assigns the nine-parallax images representing the “stereoscopic image ab” to the section B, as illustrated in FIG. 10. When the reference viewpoint is changed from the “viewpoint ab” to the “viewpoint b”, the controller 18 assigns the nine-parallax images representing the “stereoscopic image ab” to the section A, and assigns the nine-parallax images representing the “stereoscopic image b” to the section B, as illustrated in FIG. 10.

Also explained above is an example in which the display area is divided into two sections. However, the embodiment may also represent an example in which the display area is divided into three or more sections. For example, the controller 18 sets “a section A, a section B, and a sections C” that are three parts of the display area of the monitor 2 divided in a direction from the left to the right, as illustrated in FIG. 11. By setting three sections, the controller 18 can perform the second control in the manner illustrated in FIG. 11. For example, it is assumed that the reference viewpoint is changed in a sequence of the “viewpoint a”, the “viewpoint da”, the “viewpoint ab”, and the “viewpoint b”, in the same manner as in the example explained above.

In such a case, to begin with, the controller 18 assigns the nine-parallax images representing the “stereoscopic image a” to the section A, the section B, and the section C, as illustrated in FIG. 11. When the reference viewpoint is changed to the left to the “viewpoint da” from the “viewpoint a”, the controller 18 assigns the nine-parallax images representing the “stereoscopic image a” to the section B and the section C, and assigns the nine-parallax images representing the “stereoscopic image da” to the section A located on the left side, as illustrated in FIG. 11.

When the reference viewpoint is changed from “viewpoint da” to the “viewpoint ab” that is further on the right side of the “viewpoint a”, the controller 18 assigns the nine-parallax images representing the “stereoscopic image da” to the section A on the left side, assigns the nine-parallax images representing the “stereoscopic image a” to the section B located at the center, and assigns the nine-parallax images representing the “stereoscopic image ab” to the section C located on the right side, as illustrated in FIG. 11.

When the reference viewpoint is changed from the “viewpoint ab” to the “viewpoint b” located further on the right side, the controller 18 keeps assigning the nine-parallax images representing the “stereoscopic image da” to the section A located on the left side, changes the assignment of the nine-parallax images representing the “stereoscopic image ab” from the section C to the section B located on the center, and assigns the nine-parallax images representing the “stereoscopic image b” to the section C located on the right side, as illustrated in FIG. 11.

Explained in the explanation above is an example in which the display area is divided in the lateral direction, and the reference viewpoint position is changed in the lateral direction. In such a case, because the direction in which the display area is divided is the same as the direction in which the reference viewpoint position is changed, the observer can perceive the volume data without feeling awkward.

However, the reference viewpoint position could be changed not only in the lateral direction, but also in a vertical direction, for example. Even when the reference viewpoint position is changed in the vertical direction, an observer can still observe three-dimensional ultrasound image data from a wide area if the parallax image group based on the reference viewpoint after the change and the parallax image group based on the reference viewpoint before the change are displayed simultaneously by using a lateral direction as the direction in which the display area is divided, in the manner explained above. However, when the display area is divided in the lateral direction, because the stereoscopic images before and after the change are sequentially switched and displayed laterally despite the reference viewpoint is changed in the vertical direction, the observer is caused to feel awkward.

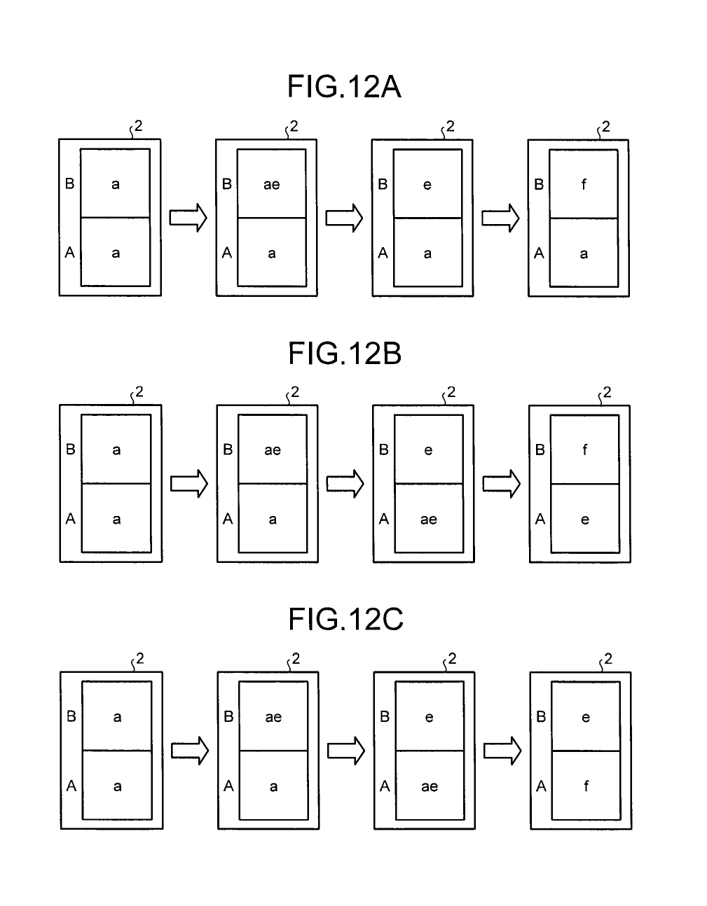

Therefore, the controller 18 may also execute a variation to be described below as the second control. In other words, the controller 18 changes the direction in which the display area is divided into a plurality of sections, depending on how the reference viewpoint position is moved. FIGS. 12A, 12B, and 12C are schematics for explaining for a variation related to how the display area is divided.

For example, it is assumed that the reference viewpoint changes in a vertical direction sequentially from the “viewpoint a”, the “viewpoint ae” located between the “viewpoint a” and the “viewpoint e”, the “viewpoint e”, and to the “viewpoint f”. In such a case, the controller 18 sets “a section A and a section B” that are two sections of the display area of the monitor 2 divided in a direction from the bottom to the top, for example, as illustrated in FIGS. 12A, 12B, and 12C.

If the parallax image group before the change that is the first parallax image group is to be fixed to the parallax image group using the first reference viewpoint received, the controller executes the second control in accordance with the pattern illustrated in FIG. 12A. In other words, as illustrated in FIG. 12A, to begin with, the controller 18 assigns the nine-parallax images representing the “stereoscopic image a” to the section A and to the section B. When the reference viewpoint is changed from the “viewpoint a” to the “viewpoint ae”, the controller 18 assigns the nine-parallax images representing the “stereoscopic image a” to the section A, and assigns the nine-parallax images representing the “stereoscopic image ae” being the nine-parallax images at the “viewpoint ae” to the section B, as illustrated in FIG. 12A.

When the reference viewpoint is changed from the “viewpoint ae” to the “viewpoint e”, the controller 18 assigns the nine-parallax images representing the “stereoscopic image a” to the section A, and assigns the nine-parallax images representing the “stereoscopic image e” being the nine-parallax images at the “viewpoint e” to the section B, as illustrated in FIG. 12A. When the reference viewpoint is changed from the “viewpoint e” to the “viewpoint f”, the controller 18 assigns the nine-parallax images representing the “stereoscopic image a” to the section A, and assigns the nine-parallax images representing the “stereoscopic image f” being the nine-parallax images at the “viewpoint f” to the section B, as illustrated in FIG. 12A.

If the parallax image group immediately before the change is to be assigned to the section A as a parallax image group before the change that is the first parallax image group, and the parallax image group after the change is to be assigned to the section B, the controller executes the second control in a pattern illustrated in FIG. 12B. In other words, to begin with, the controller 18 assigns the nine-parallax images representing the “stereoscopic image a” to the section A and to the section B, as illustrated in FIG. 12B. When the reference viewpoint is changed from the “viewpoint a” to the “viewpoint ae”, the controller 18 assigns the nine-parallax images representing the “stereoscopic image a” to the section A, and assigns the nine-parallax images representing the “stereoscopic image ae” to the section B, as illustrated in FIG. 12B.

When the reference viewpoint is changed from the “viewpoint ae” to the “viewpoint e”, the controller 18 assigns the nine-parallax images representing the “stereoscopic image ae” to the section A, and assigns the nine-parallax images representing the “stereoscopic image e” to the section B, as illustrated in FIG. 12B. When the reference viewpoint is changed from the “viewpoint e” to the “viewpoint f”, the controller 18 assigns the nine-parallax images representing the “stereoscopic image e” to the section A, and assigns the nine-parallax images representing the “stereoscopic image f” to the section B, as illustrated in FIG. 12B.

If the parallax image group immediately before the change is used as the parallax image group before the change that is the first parallax image group, and the parallax image groups are assigned in a manner corresponding to the direction in which the reference viewpoint is changed, the controller executes the second control in a pattern illustrated in FIG. 12C. In other words, to begin with, the controller 18 assigns nine-parallax images representing the “stereoscopic image a” to the section A and to the section B, as illustrated in FIG. 12C. When the reference viewpoint is changed from the “viewpoint a” to the “viewpoint ae” in an upward direction, the controller 18 assigns the nine-parallax images representing the “stereoscopic image a” to the section A, which is a section located on the bottom, and assigns the nine-parallax images representing the “stereoscopic image ae” to the section B, which is a section located on the top, as illustrated in FIG. 12C.

When the reference viewpoint is changed from the “viewpoint ae” to the “viewpoint e” in an upward direction, the controller 18 assigns the nine-parallax images representing the “stereoscopic image ae” to the lower section A, and assigns the nine-parallax images representing the “stereoscopic image e” to the upper section B, as illustrated in FIG. 12C. When the reference viewpoint is changed from the “viewpoint e” to the “viewpoint f” downwardly, the controller 18 assigns the nine-parallax images representing the “stereoscopic image f” to the lower section A, and assigns the nine-parallax images representing the “stereoscopic image e” to the upper section B, as illustrated in FIG. 12C.

Explained using FIGS. 8 to 12 is an example in which the direction in which the reference viewpoint is changed is either a lateral direction or a vertical direction. However, the control performed by the controller 18 explained in the embodiment is also executable even when the direction in which the reference viewpoint is changed is a diagonal direction while the direction in which the display area is divided is fixed to the lateral direction or the vertical direction. Furthermore, displayed in the example explained using FIGS. 8 to 12 is the synthesized image group in which the parallax image group based on the first reference viewpoint position is arranged twice in parallel. However, the embodiment may represent an example in which the parallax image group that is based on the first reference viewpoint position is displayed on the entire display area of the monitor 2 as it is.

Because the controller 18 causes the parallax image synthesizer 16b to generate a synthesized image group in which a parallax image group before the change and a parallax image group after the change is synthesized in a manner corresponding to the pattern in which the display area is divided, and displays the synthesized image group onto the monitor 2 being a stereoscopic monitor, an observer of the monitor 2 can stereoscopically observe the three-dimensional medical image data simultaneously from a wide area.

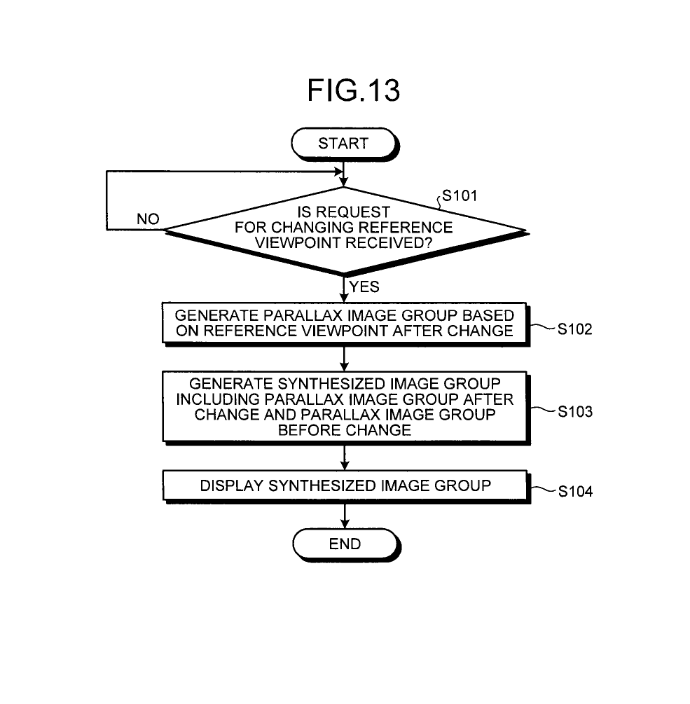

A process performed by the ultrasonic diagnostic apparatus according to the first embodiment will now be explained with reference to FIG. 13. FIG. 13 is a flowchart for explaining the process performed by the ultrasonic diagnostic apparatus according to the first embodiment. Explained below is a process after the parallax image group is generated from volume data based on the first reference viewpoint position, and displayed onto the monitor.

As illustrated in FIG. 13, the controller 18 in the ultrasonic diagnostic apparatus according to the first embodiment determines if a request for changing the reference viewpoint is received (Step S101). If any request for changing the reference viewpoint is not received (No at Step S101), the controller 18 waits until a request for changing the reference viewpoint is received.

If a request for changing the reference viewpoint is received (Yes at Step S101), the rendering processor 16a generates a parallax image group based on the reference viewpoint after the change, under the control of the controller 18 (Step S102).

The parallax image synthesizer 16b then generates a synthesized image group including a parallax image group after the change and a parallax image group before the change, in a manner corresponding to the pattern in which the display area of the monitor 2 is divided, under the control of the controller 18 (Step S103).

The monitor 2 then displays the synthesized image group under the control of the controller 18 (Step S104), and the process is ended. The ultrasonic diagnostic apparatus according to the first embodiment performs Steps S102 to S104 repeatedly every time a request for changing the reference viewpoint is received.

As described above, in the first embodiment, the controller 18 receives a change in the reference viewpoint position, and causes the rendering processor 16a to generate a parallax image group based on the reference viewpoint after the change thus received. The controller 18 then assigns and displays the first parallax image group that is based on the reference viewpoint after the change and the second parallax image that is based on the reference viewpoint before the change to and in the respective sections that are divided parts of the display area of the monitor 2. Specifically, the controller 18 causes the parallax image synthesizer 16b to generate a synthesized image group in which parallax image groups before and after the change are synthesized, in a manner corresponding to the pattern in which the display area is divided, and displays the synthesized image group onto the monitor 2 that is a stereoscopic monitor. Therefore, in the first embodiment, three-dimensional ultrasound image data can be stereoscopically observed simultaneously from a wide area. For example, by performing such a control when a blood vessel, e.g., the coronary artery, running in a manner surrounding a heart is to be observed, an observer can observe stereoscopic images of the coronary artery using a plurality of viewpoints simultaneously with a wide view angle.

Furthermore, in the first embodiment, because a request for changing the reference viewpoint position is acquired from an observer using the camera 2a, the input device 3, and the like as an interface, the observer can observe stereoscopic images from a plurality of desired viewpoints easily.

Furthermore, in the first embodiment, because the pattern in which the display area is divided can be changed depending on the direction in which the reference viewpoint position is changed, an observer can observe a stereoscopic image from a plurality of desired viewpoints without feeling awkward.

In the embodiment described above, for example, the nine-parallax images need to be generated every time the reference viewpoint is changed, and it might result in an increase in a processing load of the rendering processor 16a, and the real-timeness in displaying the synthesized image group may be reduced. In response to this issue, the controller 18 may perform a control for reducing the parallax number in the manner explained below.

In other words, in a variation of the first embodiment, as a parallax image group based on the reference viewpoint, the controller 18 causes the rendering processor 16a to generate a parallax-number-reduced parallax image group including parallax images having its parallax number reduced from the given parallax number, including the reference viewpoint at the center. The controller 18 then controls to display at least one of a plurality of parallax image groups that are based on each of a plurality of reference viewpoints as a parallax-number-reduced parallax image group. Specifically, the controller 18 controls to display at least one of the first parallax image group and the second parallax image group as a parallax-number-reduced parallax image group. For example, the controller 18 assigns and displays a parallax-number-reduced parallax image group based on the reference viewpoint after the change and a parallax-number-reduced parallax image group based on the reference viewpoint before the change to a plurality of sections.

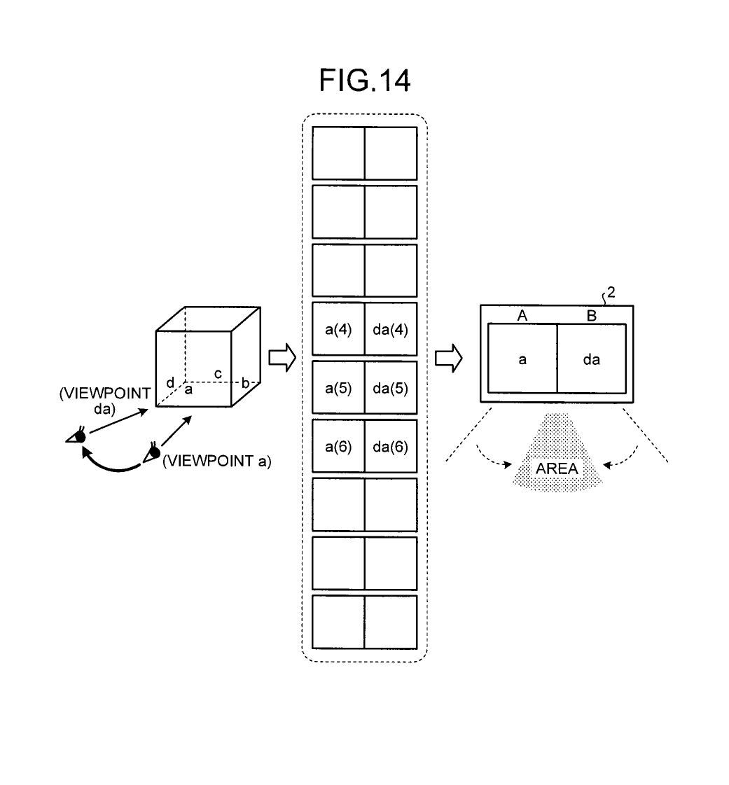

FIG. 14 is a schematic for explaining the variation of the first embodiment. For example, the controller 18 specifies to reduce the parallax number of the nine-parallax images to be displayed onto the monitor 2 to “three”. It is assumed herein that the viewpoint (5) is the reference viewpoint among the viewpoints (1) to (9) used in generating the nine-parallax images. In such a condition, the controller 18 specifies to cause the rendering processor 16a to generate three-parallax images (three parallax images) using the reference viewpoint (5), and the viewpoint (4) and the viewpoint (6) both of which have a parallax angle of “one degree” from the reference viewpoint (5) at the center.

The controller 18 also specifies to cause the rendering processor 16a to generate images having every pixel specified with the white color, for example, as images in replacement of the parallax image group using the viewpoint (1) to viewpoint (3) and the viewpoint (7) to the viewpoint (9). With such conditions specified, it is now assumed that the controller 18 receives a change of the reference viewpoint from the “viewpoint a” to the “viewpoint da”, as illustrated in FIG. 14, via the input device 3.

The controller 18 then causes the rendering processor 16a to generate three-parallax images “da(3), da(4), and da(5)” by setting three viewpoints including the viewpoint da as the center. Because the rendering processor 16a has generated three-parallax images “a(3), a(4), and a(5)” from the three viewpoints including the viewpoint a as the center, the controller 18 causes the parallax image synthesizer 16b to generate a synthesized image group including a synthesized image “a(4), da(4)”, a synthesized image “a(5), da(5)”, and synthesized image “a(6), da(6)”, as illustrated in FIG. 14. The controller 18 then control causes the parallax image synthesizer 16b to generate a synthesized image group that is synthesized with images having every pixel specified with the white color, in replacement of the synthesized image group using the viewpoint (1) to the viewpoint (3) and the viewpoint (7) to the viewpoint (9).

The controller 18 then displays the synthesized image groups thus generated onto the monitor 2. In this manner, the observer can observe a “stereoscopic image a” in which the volume data is observed from the viewpoint a in the section A, and observe a “stereoscopic image da” in which the volume data is observed from the viewpoint da in the section B, as illustrated in FIG. 14. Because the parallax number is reduced, the area in which the observer can perceive the “stereoscopic image a” and the “stereoscopic image da” simultaneously is reduced as illustrated in FIG. 14. In the variation, a request for changing the reference viewpoint is preferably made via the input device 3, without causing the observer to move. The stereoscopic image displayed as a parallax-number-reduced parallax image group may be both of the first parallax image group and the second parallax image group, in the manner described above, or one of the first parallax image group and the second parallax image group. Such a selection may be made manually by an operator, or may be made by allowing the controller 18 to determine automatically depending on the processing load of the rendering processor 16a, for example.

As described above, in the variation of the first embodiment, the parallax image groups before and after the reference viewpoint position is changed are simultaneously displayed in a reduced parallax number. Therefore, the real-timeness in displaying stereoscopic images for a plurality of viewpoints can be ensured.

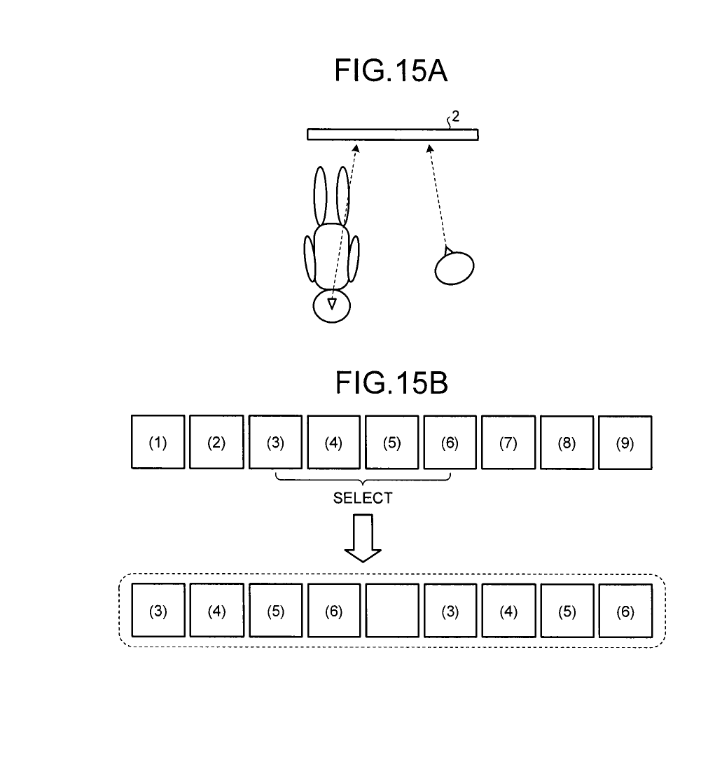

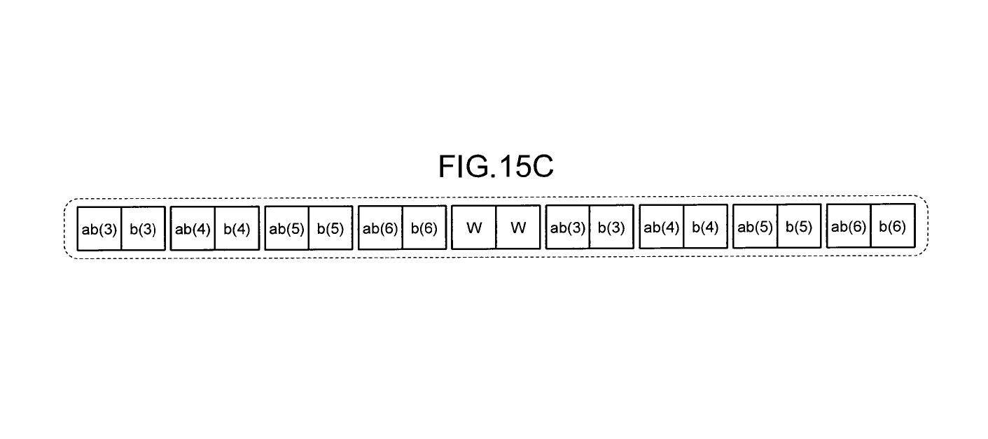

Explained in a second embodiment with reference to FIGS. 15A, 15B, and 15C is a controlling process performed by the controller 18 when there are a plurality of observers of the stereoscopic display monitor. FIGS. 15A, 15B, and 15C are schematics for explaining the second embodiment.

For example, when an ultrasound examination is conducted, the position of the examiner and the position of the subject P lying on a bed are predetermined. In other words, the viewpoint position (observation position) of the examiner with respect to the monitor 2 and the viewpoint position (observation position) of the subject P with respect to the monitor 2 are predetermined, as illustrated in FIG. 15A. Therefore, in the second embodiment, the viewpoint position of the examiner with respect to the monitor 2 and the viewpoint position of the subject P with respect to the monitor 2 are stored in the internal storage 19 as preset information. In the second embodiment, a control is performed based on the preset information so that the examiner and the subject P can look at a stereoscopic image simultaneously based on the same synthesized image group.

In other words, in the second embodiment, when observation positions of a plurality of observers observing the monitor 2 are preset, the controller 18 controls to select an image group with which the observers at their respective observation positions look at an identical image from a parallax image group, and to display the image group thus selected in each of the sections.

For example, the controller 18 selects “the parallax image at the viewpoint (3), the parallax image at the viewpoint (4), the parallax image at the reference viewpoint (5), and the parallax image at the viewpoint (6)” as a parallax image group to be displayed, from the nine-parallax images consisting of the parallax images at the viewpoint (1) to the viewpoint (9), based on the preset information. The controller 18 then determines to arrange the parallax image group to be displayed in the manner illustrated in FIG. 15B, so as to enable both of the examiner and the subject P to observe.

In the example illustrated in FIG. 15B, the controller 18 determines to arrange the parallax image group to be displayed in the pixels 202 that are arranged in nine columns (see FIG. 3), in an order of the “the parallax images at the viewpoint (3) to the viewpoint (6), an image having every pixel specified with the white color (hereinafter, an image W), and the parallax images at the viewpoint (3) to the viewpoint (6)”.

With such a setting specified, it is assumed that the controller 18 receives a change in the reference viewpoint from the “viewpoint ab” to the “viewpoint b”. In such a case, the controller 18 sets four viewpoints including the viewpoint b as the center, to cause the rendering processor 16a to generate four parallax images “b(3), b(4), b(5), and b(6)”. The rendering processor 16a already generated four parallax images “ab(3), ab(4), ab(5), ab(6)”, from the four viewpoints including the viewpoint ab at the center. The controller 18 then causes the parallax image synthesizer 16b to generate a group of synthesized image “ab(3), b(3)”, a synthesized image “ab(4), b(4)”, a synthesized image “ab(5), b(5)”, a synthesized image “ab(6), b(6)”, and a synthesized image “image W, image W”.

The controller 18 then displays the group of the synthesized images “ab(3), b(3)” to “ab(6), b(6)”, the synthesized image “image W, image W”, the synthesized images “ab(3), b(3)” to “ab(6), b(6)” onto the monitor 2, as illustrated in FIG. 15C, based on the arrangement explained in FIG. 15B. In this manner, both of the examiner and the subject P can observe the “stereoscopic image ab” in which the volume data is observed from the viewpoint ab in the section A, and the “stereoscopic image b” in which the volume data is observed from the viewpoint b in the section B.

As described above, in the second embodiment, even if there are a plurality of observers, all of the observers can stereoscopically observe three-dimensional ultrasound image data simultaneously from a wide area.

Explained in the first and the second embodiments is an example in which the monitor 2 is a nine-parallax monitor. However, the first and the second embodiments described above are also applicable to an example in which the monitor 2 is a two-parallax monitor.

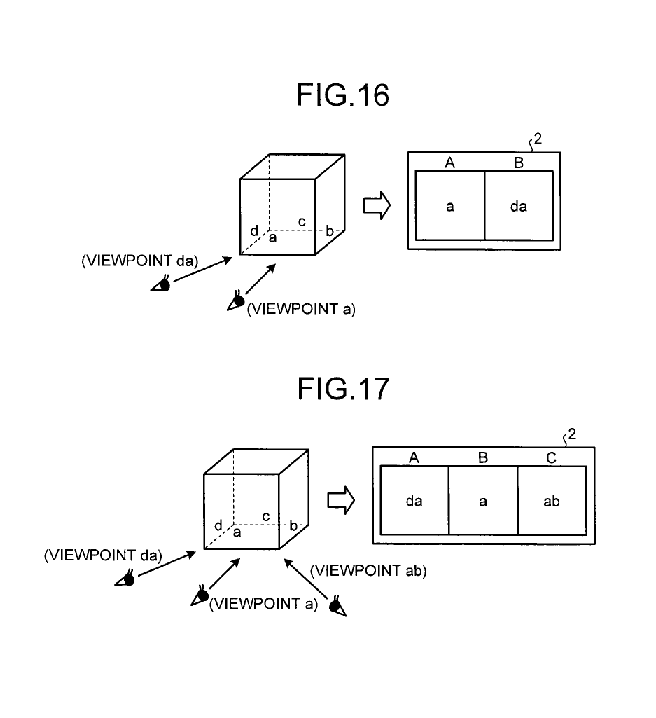

Furthermore, explained in the first and the second embodiments is an example in which a plurality of reference viewpoint positions are received, by sequentially receiving changes in the reference viewpoint position in a temporal order. However, the first and the second embodiments described above are also applicable to an example in which a plurality of reference viewpoint positions are received simultaneously. FIGS. 16 and 17 are schematics for explaining a variation of the first and the second embodiments.

For example, an observer specifies the “viewpoint a” and the “viewpoint da” as two reference viewpoints, as illustrated in FIG. 16, using a joystick, a trackball, or a mouse, for example. In this manner, the controller 18 receives the “viewpoint a” and the “viewpoint da” as the two reference viewpoints. The rendering processor 16a then generates nine-parallax images “a(1) to a(9)” having the “viewpoint a” as the reference viewpoint, and the nine-parallax images “da(1) to da(9)” having “viewpoint da” as the reference viewpoint, under the control of the controller 18. The parallax image synthesizer 16b then generates a synthesized image group in which each of the nine-parallax images “a(1) to a(9)” and corresponding one of the nine-parallax images “da(1) to da(9) are synthesized, under the control of the controller 18. The monitor 2 then displays the “stereoscopic image a” in the section A, and displays the “stereoscopic image da” in the section B, as illustrated in FIG. 16, for example.

The number of reference viewpoint positions received by the controller 18 in the variation may be three or more. For example, an observer may specify the “viewpoint a”, the “viewpoint da”, and the “viewpoint ab” as three reference viewpoints, in the manner illustrated in FIG. 17. In response, the controller 18 receives the “viewpoint a”, the “viewpoint da”, and the “viewpoint ab” as the three reference viewpoints. The rendering processor 16a then generates nine-parallax images “a(1) to a(9)” having the “viewpoint a” as the reference viewpoint, nine-parallax images “da(1) to da(9)” having the “viewpoint da” as the reference viewpoint, and nine-parallax images “ab(1) to ab(9)”having the “viewpoint ab” as the reference viewpoint, under the control of the controller 18. The parallax image synthesizer 16b then generates a synthesized image group in which each of the nine-parallax images “a(1) to a(9)” is synthesized with corresponding one of the nine-parallax images “da(1) to da(9)” and corresponding one of the nine-parallax images “ab(1) to ab(9)”, under the control of the controller 18. The monitor 2 then displays the “stereoscopic image da” in the section A, displays the “stereoscopic image a” in the section B, and displays the “stereoscopic image ab” in the section C, for example, in the manner illustrated in FIG. 17.

The reference viewpoint positions received simultaneously by the controller 18 in the variation may be specified by an observer, in the manner described above, or may be preconfigured from the beginning. Furthermore, the variation may also represent an example in which a parallax-number-reduced parallax image group is used.

Explained in the first embodiment, the second embodiment, and the variations thereof is an example in which control is executed in an ultrasonic diagnostic apparatus being a medical image diagnostic apparatus for allowing three-dimensional ultrasound image data to be stereoscopically observed simultaneously from a wide area. However, the processes explained in the first embodiment, the second embodiment, and the variations thereof may be executed in a medical image diagnostic apparatus other than an ultrasonic diagnostic apparatus, such as an X-ray CT apparatus or an MRI apparatus, capable of generating volume data that is three-dimensional medical image data.

Furthermore, the processes explained in the first embodiment, the second embodiment, and the variations thereof may be executed by an image processing apparatus provided independently from a medical image diagnostic apparatus. Specifically, these processes may be those performed by an image processing apparatus including the functions of the volume data processor 16 and the controller 18 illustrated in FIG. 1 by receiving volume data that is three-dimensional medical image data from a database in picture archiving and communication systems (PACS) that are systems for managing various types of medical image data, or a database in an electronic medical record system for managing electronic medical records to which medical images are attached, and by executing the processes explained in the first embodiment, the second embodiment, and the variation.

As explained above, according to the first embodiment, the second embodiment, and the variation, three-dimensional medical image data can be stereoscopically observed simultaneously from a wide area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image diagnostic apparatus comprising:
a display unit configured to display a stereoscopic image that is perceived stereoscopically by an observer, by displaying a parallax image group that is parallax images in a given parallax number and having a given parallax angle between the images;
a rendering processor configured to generate the parallax image group by applying a volume rendering process to volume data that is three-dimensional medical image data from a plurality of viewpoints including a reference viewpoint as center;
a first controller configured to receive positions of a plurality of reference viewpoints as a position of the reference viewpoint, and to cause the rendering processor to generate a parallax image group based on each of the reference viewpoints thus received; and
a second controller configured to control to assign and display each of a plurality of parallax image groups that are based on the respective reference viewpoints to and on corresponding one of a plurality of sections that are divided parts of a display area of the display unit.

2. The medical image diagnostic apparatus according to claim 1, wherein
when the reference viewpoint positions are received as changes in the reference viewpoint sequentially received in a temporal order,
the first controller is configured, every time a change in the reference viewpoint position is received, to cause the rendering processor to generate a parallax image group based on a reference viewpoint after the change thus received,
the second controller is configured to control to assign and display a first parallax image group based on the reference viewpoint after the change and a second parallax image group based on a reference viewpoint before the change to and on corresponding one of a plurality of sections that are divided parts of a display area of the display unit.

3. The medical image diagnostic apparatus according to claim 2, further comprising a detector configured to detect a movement of the observer, wherein
the first controller is configured to receive a change in the reference viewpoint position based on a movement of the observer detected by the detector with respect to the display unit.

4. The medical image diagnostic apparatus according to claim 2, further comprising an input unit configured to receive an operation for changing the reference viewpoint position, wherein
the first controller is configured to receive a change in the reference viewpoint position based on information of an operation of the observer received by the input unit.

5. The medical image diagnostic apparatus according to claim 2, wherein the second controller is configured to change a direction in which the display area is divided into the sections based on a direction in which the reference viewpoint position is moved.

6. The medical image diagnostic apparatus according to claim 1, wherein
the first controller is configured to cause the rendering processor to generate a parallax-number-reduced parallax image group with parallax images having a parallax number reduced from the given parallax number, the parallax number including the reference viewpoint as center, as a parallax image group based on the reference viewpoint, and
the second controller is configured to control to display at least one of a plurality of parallax image groups that are based on the respective reference viewpoint positions as the parallax-number-reduced parallax image group.

7. The medical image diagnostic apparatus according to claim 1, wherein
when observation positions of a plurality of observers observing the display unit are predetermined,
the second controller is configured to control to select, from the parallax image group, an image group with which the observers at their respective observation positions look at an identical image, and to display the image group thus selected in each of the sections.

8. An image processing apparatus comprising:
a display unit configured to display a stereoscopic image that is perceived stereoscopically by an observer, by displaying a parallax image group that is parallax images in a given parallax number and having a given parallax angle between the images;
a rendering processor configured to generate the parallax image group by applying a volume rendering process to volume data that is three-dimensional medical image data from a plurality of viewpoints including a reference viewpoint as center;
a first controller configured to receive positions of a plurality of reference viewpoints as a position of the reference viewpoint, and to cause the rendering processor to generate a parallax image group based on each of the reference viewpoints thus received; and
a second controller configured to control to assign and display each of a plurality of parallax image groups that are based on the respective reference viewpoints to and on corresponding one of a plurality of sections that are divided parts of a display area of the display unit.

9. An ultrasonic diagnostic apparatus comprising:
a display unit configured to display a stereoscopic image that is perceived stereoscopically by an observer, by displaying a parallax image group that is parallax images in a given parallax number and having a given parallax angle between the images;
a rendering processor configured to generate the parallax image group by applying a volume rendering process to volume data that is three-dimensional ultrasound image data from a plurality of viewpoints including a reference viewpoint as center;
a first controller configured to receive positions of a plurality of reference viewpoints as a position of the reference viewpoint, and to cause the rendering processor to generate a parallax image group based on each of the reference viewpoints thus received; and
a second controller configured to control to assign and display each of a plurality of parallax image groups that are based on the respective reference viewpoints to and on corresponding one of a plurality of sections that are divided parts of a display area of the display unit.
